(19) United States
(12) Patent Application Publication
(10) Pub. No.: US 2003/0034829 A1
(43) Pub. Date: Feb. 20, 2003

(54) APPARATUS FOR ON-CHIP REFERENCE VOLTAGE GENERATOR FOR RECEIVERS IN HIGH SPEED SINGLE-ENDED DATA LINK

(76) Inventors: Chung-Hsiao R. Wu, Sunnyvale, CA (US); Jyh-Ming Jong, Saratoga, CA (US); Prabhansu Chakrabarti, Sunnyvale, CA (US); Leo Yuan, Los Altos, CA (US)

Correspondence Address: brian M. Berliner, Esq, O'Melveny & Myers LLP, 400 South Hope Street, Los Angeles, CA, 90071-2899, US

(21) Appl. No.: 09/931,696

(22) Filed: Aug. 15, 2001

(51) Int. Cl. G05F 1/10

(52) U.S. Cl. 327/540

(57) ABSTRACT

An on-chip DC voltage generator providing a marginable reference voltage signal is described. The present invention is a CMOS-based integrated circuit that generates a marginable reference voltage level. The present invention provides a process insensitive reference voltage signal and may be configured so as to generate a ground-bounce-noise free signal.

### BACKGROUND OF THE INVENTION

1. Field of the Invention

This invention relates to the field of DC voltage generators and in particular to an on-chip DC voltage generator.

2. Background Art

The operation of integrated circuits often requires that a signal be compared to a reference level such as a reference voltage. An external DC voltage generator is traditionally used to provide this reference signal. Using an external DC voltage generator, as will be further explained below, is disadvantageous in terms of the physical limitations of the IC and the complexity it adds to the system.

The generator is typically either a voltage divider or resistor network. Decoupling capacitors are often used to bypass the frequency-dependent noise and prevent the noise from injecting into the chip. This reference signal, Vref, is usually set at the center of the data eye pattern. A data eye pattern is the superposition of the ones and zeroes output from a high speed system or circuit. This pattern is obtained by sampling a long pseudo-random-bit-sequence output from the system under study. The horizontal width of the lines gives the jitter (phase noise) and the rise and fall times of the data pulses can be measured from the crossings of the sampled signals.

A prior art voltage generator configuration is illustrated in FIG. 1. FIG. 1 comprises a chip 100 connected to M external voltage generators 105. Each external voltage generator 105 is associated to a bank of N data lines 110 through N comparators 115. Each voltage generator 105 is connected to common ground 120. In operation each voltage generator 105 supplies a reference voltage to each comparator 115 in its associated bank. The reference voltages may differ as between each generator 105.

A comparator is an operational amplifier, or op-amp. A comparator comprises two input terminals, positive (+) and negative (−). The signal generated by a comparator indicates which of these two voltages is greater:

Vo=A(Vp−Vn)

where A is the open-loop voltage gain of the amplifier, Vp is the positive input voltage and Vn is the negative input voltage. Both Vp and Vn are node voltages with respect to ground.

There are numerous drawbacks inherent in the use of an external reference voltage source. In coupling the source to the chip, the leads necessarily occupy package pin counts and IO pads on the chip. This configuration generates noise coupling from the board, as well as noise generated by inductive Vref pins. The use of multiple components complicates board routing. Finally, external reference voltage generators require R/C components.

### SUMMARY OF THE INVENTION

An on-chip DC voltage generator providing a marginable reference voltage signal is described herein. Embodiments of the present invention are Complementary Metal Oxide Semiconductor (CMOS)-based integrated circuits that generate marginable reference voltage level. One embodiment of the present invention generates a process insensitive reference voltage signal. A separate embodiment of the present invention generates a ground-bounce-noise free reference voltage signal. Another embodiment of the present invention implements a voltage margining scheme. A marginable DC voltage generator may produce several discrete Vref levels. This circuit is said to be marginable because the several voltage levels are available for use at any time.

### BRIEF DESCRIPTION OF THE DRAWINGS

FIG. 1 is a block diagram illustrating a prior art external DC reference voltage generator configuration.

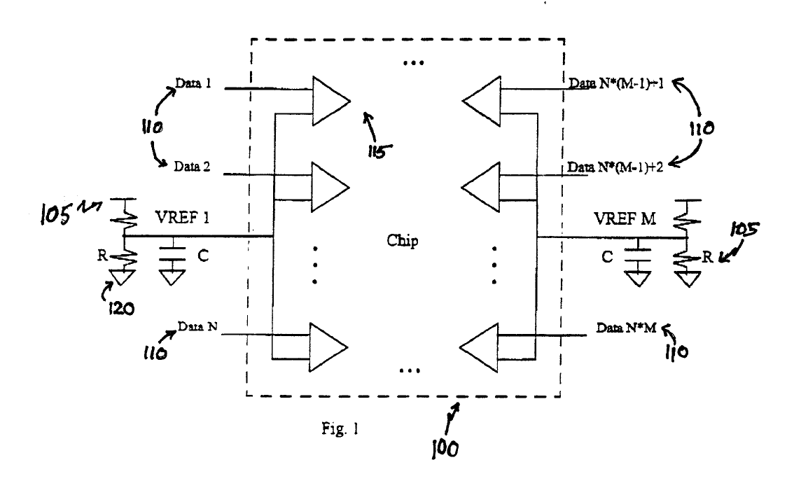

FIG. 2 is a block diagram illustrating the present invention.

FIG. 3 is a block diagram illustrating the control methodology of the present invention.

FIG. 4 is a circuit diagram illustrating a process-independent embodiment of the present invention.

FIG. 5 is a circuit diagram illustrating a ground-bounce-noise free embodiment of the present invention.

### DETAILED DESCRIPTION OF THE INVENTION

An novel on-chip DC voltage generator providing a marginable reference voltage signal is described. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

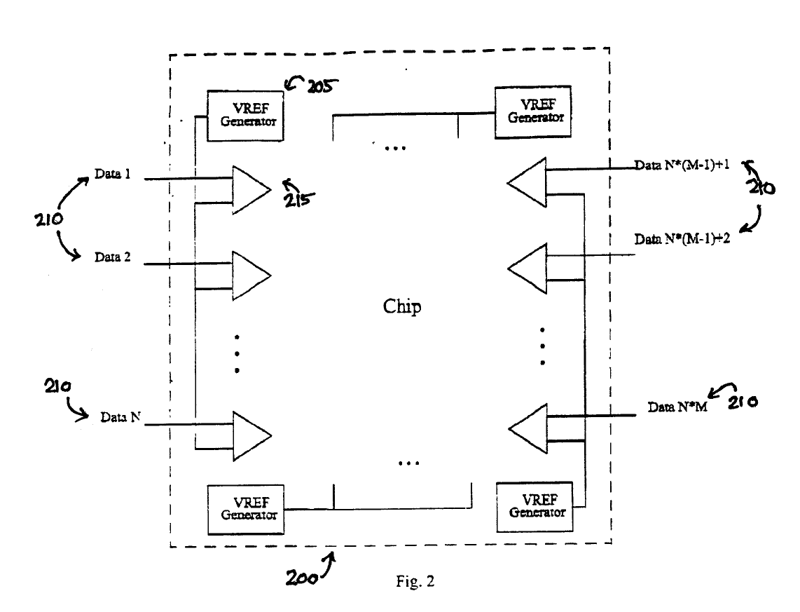

FIG. 2 is a block diagram illustrating the present invention. Chip 200 is connected to M on-chip voltage generators 205. Each on-chip voltage generator 205 is associated to a bank of N data lines 210 through N comparators 215. In operation each voltage generator 205 supplies a reference voltage to each comparator 215 in its associated bank. The reference voltages may differ as between each generator 205.

An IC configuration in which the reference voltage generators are on-chip solves many disadvantages of an external voltage generator configuration. Manufacturing costs are lowered because package pin counts and Vref_IO pad counts are reduced. Board routing capacity is improved. Board discrete R and C component count is reduced. The path of external board noise impact to Vref is eliminated. Last, this configuration eliminates the Vref (Miller) transient current induced noise on inductive parasitic Vref package pins.

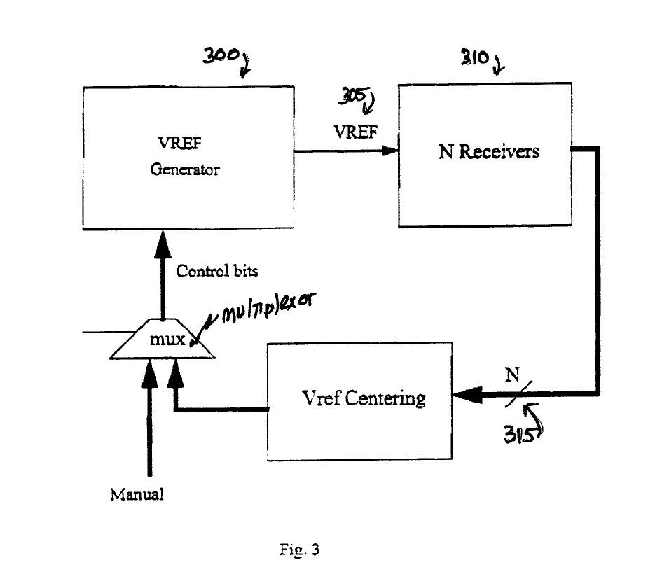

FIG. 3 is a block diagram illustrating the control methodology of the present invention. Vref generator block 300 produces a Vref signal 305. Vref 305 is received by N receivers, represented by block 310. Vref centering circuitry, represented by block 320, improves the noise margin by centering the Vref level in the received data eye pattern of the N system outputs 315. MUX 340 generates control bits 350 based on the signal generated by the Vref centering circuitry and either an automatic control or manual software control 330. Control bits 350 regulate the marginable Vref generator 300.

The feedback control system illustrated in FIG. 3 overcomes several disadvantages of external Vref generators. The configuration improves system testability and reliability. Every Application Specific Integrated Circuit (ASIC) component can be characterized on Vref margining in an on-chip configuration. Contrarily, Vref margining capability for all the ASICs is limited in an external voltage generator configuration by the inability of the hardware to reach and scope these components.

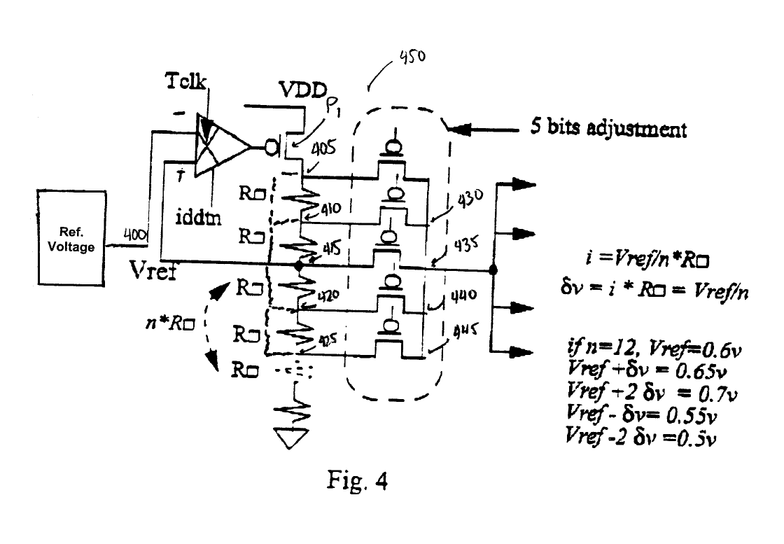

FIG. 4 is a circuit diagram illustrating a process-independent embodiment of the present invention. A five bit marginable control circuit is illustrated for exemplary purposes only. It is apparent to one skilled in the art that a marginable voltage control circuit may be comprised of any number of control bits.

In FIG. 4, current iddtn is provided as an input to a reference voltage generator and provides as output a voltage 400. The reference voltage generator may be of any well known designs of the prior art, including a voltage divider or a band gap reference voltage generator.

Comparator is coupled to node 400 at the negative input. The voltage at node 400 is reference voltage, Vref. The positive input is coupled to the voltage margining control block at node 415. The gate of P-type transistor P1 receives the output of comparator. The operation of comparator is controlled by clock signal, Tclk. A clock-based control is necessary because the signals a the positive and negative inputs may be slightly offset in time.

The source of transistor P1 is coupled to voltage source Vdd. The drain of transistor P1 is coupled to voltage margining control block at node 405.

Voltage margining control block is comprised of n resistors coupled in series. The first resistor in this array is coupled to transistor P1 at node 405. The nth resistor is coupled to common ground. Voltage margining control block is further comprised of an array of 5 P-type transistors, coupled in parallel. In construction of this circuit, n is defined to be at least as large as the number of P-type transistors in array. The resistor array is interleaved with the P-type transistor array at the source of the P-type transistors.

The voltage differential (delta V) at each level is maintained by the n resistors of equivalent resistance. Since the illustrated circuit is comprised of a five bit voltage margining control system, only the first five resistors are interleaved with the array of P-type transistors. The five control bits decide which Vref level is selected. Vref is selected at one of nodes 405, 410, 415, 420, or 425 and provided as the positive input to the comparator.

Thus, for the five level Vref generator illustrated in FIG. 4:

Delta V=Vref/n.

Assuming n=12 and Vref=0.6 v, the five levels are:

Vref+2*(Delta V)=0.7 v

Vref+(Delta V)=0.65 v

Vref=0.6 v

Vref−(Delta V)=0.55 v

Vref−2*(Delta V)=0.5 v

N leads couple to the reference voltage generator to the on-chip ASICs at node 435.

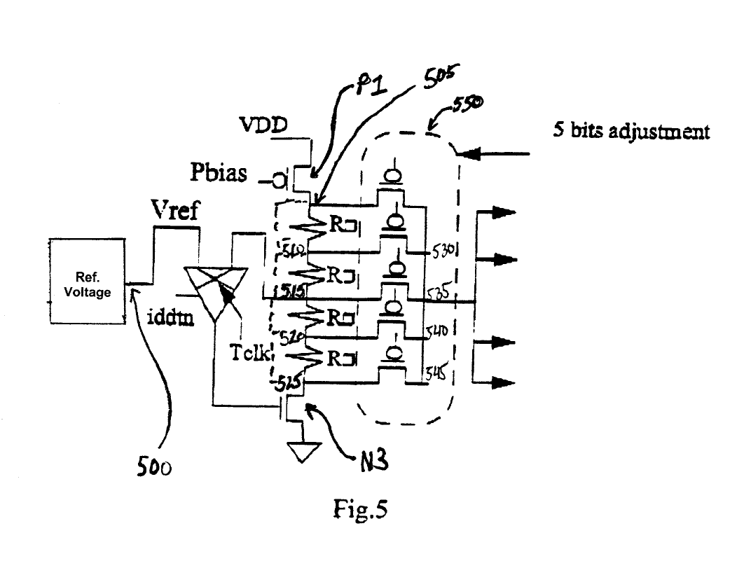

FIG. 5 is a circuit diagram illustrating a ground-bounce-noise free embodiment of the present invention. A five bit marginable control circuit is illustrated for exemplary purposes only. It is apparent to one skilled in the art that a marginable voltage control circuit may be comprised of any number of control bits.

In FIG. 5, current iddtn is provided to a reference voltage generator to provide output 500. Comparator is coupled to node 500 at the negative input. The voltage at node 500 is reference voltage, Vref. The positive input is coupled to the voltage margining control block at node 515. The gate of N-type transistor N3 receives the output of comparator. The operation of comparator is controlled by clock signal, Tclk. A clock-based control is necessary because the signals a the positive and negative inputs may be slightly offset in time.

The source of P-type transistor P1 is coupled to voltage source Vdd. The drain of transistor P1 is coupled to voltage margining control block at node 505. Transistor P1 receives bias signal, Pbias, at the gate. Pbias may be any regular, stable voltage.

The drain of transistor N3 is coupled to voltage margining control block. The source of transistor N3 is coupled to common ground.

Voltage margining control block 550 is comprised of n resistors coupled in series. The first resistor in this array is coupled to transistor P1 at node 505. The nth resistor is coupled to common ground. Voltage margining control block is further comprised of an array of 5 P-type transistors, coupled in parallel. In construction of this circuit, n is defined to be at least as large as the number of P-type transistors in array. The resistor array is interleaved with the P-type transistor array at the source of the P-type transistors.

The voltage differential (delta V) at each level is maintained by the n resistors of equivalent resistance. Since the illustrated circuit is comprised of a five bit voltage margining control system, only the first five resistors are interleaved with the array of P-type transistors. The five control bits decide which Vref level is selected. Vref is selected at one of nodes 505, 510, 515, 520, or 525 and provided as the positive input to the comparator.

Thus, for the five level Vref generator illustrated in FIG. 5:

Delta V=Vref/n.

Assuming n=12 and Vref=0.6 v, the five levels are:

Vref+2*(Delta V)=0.7 v

Vref+(Delta V)=0.65 v

Vref=0.6 v

Vref−(Delta V)=0.55 v

Vref−2*(Delta V)=0.5 v

N leads couple to the reference voltage generator to the on-chip ASICs at node 535.

Thus, a novel, on-chip DC voltage generator providing marginable voltage has been described.

We claim:

1. An on-chip DC voltage generator circuit comprising:
first resistor means coupled to a first voltage means;
first transistor means of a first conductivity type coupled to said first resistor means;
second transistor means of said first conductivity type coupled to said first transistor means at a first node;
second resistor means coupled to said second transistor means and common ground means;
third transistor means of a second conductivity type coupled to a second voltage means;
comparator means coupled to said first node at a negative terminal and to a second node at a positive terminal, the output of said comparator means coupled to the gate of said third transistor means;
margining means coupled to said third transistor means at a third node and to said comparator means at said second node; and
signal transmission means coupled to said margining means at a fourth node.

2. The circuit of claim 1 wherein said first conductivity type is N-type.

3. An on-chip DC voltage generator circuit comprising:
first resistor means coupled to a first voltage means;
first transistor means of a first conductivity type coupled to said first resistor means;
second transistor means of said first conductivity type coupled to said first transistor means at a first node;
second resistor means coupled to said second transistor means and common ground means;
comparator means coupled to said first node at the negative terminal;
third transistor means of a second conductivity type coupled to a second voltage means;
bias means connected to the gate of said third transistor means;
margining means coupled to the positive terminal of said comparator means at a second node and coupled to said third transistor means at a third node;
fourth transistor means of said first conductivity type coupled to said margining means at a fourth node and to said common ground means, the gate of said fourth transistor means coupled to the output of said comparator means; and
signal transmission means coupled to said margining means at a fifth node.

4. The circuit of claim 3 wherein said first conductivity type is N-type.

5. The circuit of claims 2 or 4 wherein said margining means comprises:
a first plurality of resistor means coupled in series, said first plurality of resistor means coupled to said third transistor means at said third node and coupled to said second node such that the voltage at said second node is Vref; and
a second plurality of transistor means of the second conductivity type coupled in parallel, the drains of said second plurality of transistor means interspersed with said first plurality of resistor means, wherein said first plurality is at least at large as said second plurality.
